(19) United States
(12) Patent Application Publication
(10) Pub. No.: US 2024/0408847 A1
(43) Pub. Date: Dec. 12, 2024

(54) CARBON CAPTURE SYSTEMS AND METHODS

(71) Applicants: Trustees of Tufts College, Medford, MA (US); Board of Regents, The University of Texas System, Austin, TX (US); Imperial College Innovations Limited, London (GB); Massachusetts Institute of Technology, Cambridge, MA (US)

(72) Inventors: Marc Hodes, Medford, MA (US); Vaibhav Bahadur, Austin, TX (US); Darren G. Crowdy, London (GB); Demetrios T. Papageorgiou, London (GB); Trevor Alan Hatton, Cambridge, MA (US)

(21) Appl. No.: 18/697,525

(22) PCT Filed: Oct. 3, 2022
(86) PCT No.: PCT/US22/77489

§ 371 Date: Apr. 1, 2024

Related U.S. Application Data
(60) Provisional application No. 63/261,953, filed on Oct. 1, 2021.

(51) Int. Cl. B32B 15/08; B01D 53/14; B32B 3/26; B32B 27/20; B32B 27/32

(52) U.S. Cl. CPC B32B 15/08; B01D 53/1475; B32B 3/266; B32B 27/20; B32B 27/322; B01D 2257/504; B32B 2250/02; B32B 2255/10; B32B 2255/26; B32B 2307/30

(57) ABSTRACT

A carbon-capture device and related processes are disclosed. The devices include substrate surfaces having a textured surfaces and a liquid sorbent contacting the texture surface in either a Cassie-Baxter state, in the case of a texture omniphobic surface or a plurality of re-entrant features or a Wenzel state, in the case of a textured omniphilic surface. The liquid sorbent reversibly captures a chemical species, which can usefully be carbon dioxide. This reversible capture can be exploited to capture and sequester carbon or other chemical species of interest.

### CROSS-REFERENCE TO RELATED APPLICATIONS

This application is related to, claims priority to, and incorporates herein in its entirety for all purposes U.S. Provisional Application No. 63/261,953, filed Oct. 1, 2021.

### STATEMENT REGARDING FEDERALLY SPONSORED RESEARCH

Not applicable.

### BACKGROUND

Global warming due to emission of greenhouse gases, such as carbon dioxide, methane, and chlorofluorocarbons, remains a world-wide problem. Among the greenhouse gases, carbon dioxide has the most significant effect and it is an urgent subject to reduce the emission of carbon dioxide. Methods exist for removing carbon dioxide from gases, including chemical absorption methods, physical absorption methods, membrane separation methods, adsorptive separation methods, and cryogenic separation methods. These methods are inefficient for direct capture of CO₂ from atmospheric air.

This is, in part, attributed to significant challenges associated with current CO₂ capture methods, which include slow diffusion of CO₂ into liquid sorbents coupled with low air-sorbent contact areas, which results in large CO₂ capture hardware (driving up CAPEX and energy losses), and high energy requirements to regenerate the sorbent for reuse. Other challenges include corrosion and safety-related aspects of the sorbents.

A need exists for new CO₂ capture systems and methods that reduce, minimize, and/or eliminate one or more of the shortcomings of existing systems and methods.

### SUMMARY OF THE DISCLOSURE

The present disclosure addresses the aforementioned shortcomings by providing systems and methods that selectively and reversibly capture chemical species (e.g., CO₂) with significant enhancement in fluid-sorbent surface area by utilizing omniphobic and omniphilic surfaces. The present disclose provides, among other things, an integrated apparatus that can be used for selectively capturing a desired chemical species (e.g., CO₂) utilizing a liquid sorbent and sorbent regeneration to isolate and eventually purify that desired chemical species. Embodiments disclosed herein significantly reduce CAPEX and space requirements associated with mass transfer applications when compared to existing methods. Embodiments disclosed herein further significantly reduce energy requirements as sorbent pumping may optionally be eliminated. Further, selection of materials for the apparatus may reduce heat losses in promotion to the size reduction of the overall unit.

In one aspect, the present disclosure provides a mass transfer apparatus. The mass transfer apparatus includes a first substrate surface having a textured omniphobic surface or a plurality of re-entrant features, a second substrate surface, and a liquid sorbent positioned between the first and second substrate surface. The liquid sorbent contacts the textured omniphobic surface in a Cassie-Baxter state to form a plurality of microchannels positioned between the first substrate surface and the liquid sorbent. The plurality of microchannels have an inlet for introducing a first fluid to the plurality of microchannels and an outlet for removing the first fluid from the plurality of microchannels. The liquid sorbent is configured to reversibly capture at least one chemical species from the first liquid.

In another aspect, the present disclosure provides a mass transport apparatus. The mass transfer apparatus includes a first substrate surface having a textured omniphillic surface, a second substrate surface spaced from the first substrate surface to form at least one microchannel between the first substrate surface and the second substrate surface. The mass transport apparatus further includes a liquid sorbent positioned between the first and second substrate surface, where the liquid sorbent contacts the textured omniphillic surface in a Wenzel state. The microchannel includes an inlet for introducing a first fluid to the microchannel and an outlet for removing the first fluid from the microchannel. The liquid sorbent is configured to reversibly capture at least one chemical species from the first liquid.

These and other advantages and features of the present invention will become more apparent from the following detailed description of the preferred embodiments of the present invention when viewed in conjunction with the accompanying drawings.

### BRIEF DESCRIPTION OF THE DRAWINGS

FIG. 1 is a schematic illustration of a mass transfer apparatus having one or more omniphobic surface in accordance with some embodiments of the present disclosure.

FIG. 2 is a schematic illustration of a mass transfer apparatus having one or more omniphilic surface in accordance with some embodiments of the present disclosure.

FIG. 3 is a schematic illustration of a mass transfer apparatus having a redox active solvent and a counter electrode in accordance with some embodiments of the present disclosure.

FIG. 4(A-B) are images of substrate surface textures in an open cell arrangement in accordance with some embodiments of the present disclosure.

FIG. 5 is an image of a pillared silicon surface having an open cell arrangement in accordance with some embodiments of the present disclosure.

FIG. 6 is an image of substrate surface textures in a closed cell arrangement in accordance with some embodiments of the present disclosure.

FIG. 7 is an image of hierarchical surface textures in accordance with some embodiments of the present disclosure.

FIG. 8 is a schematic illustration of a system comprising a plurality of stacked mass transfer apparatus. Priming of the Wenzel state occurs via wicking of sorbent in side reservoir via periodic holes in ridges. During operation, front and rear louvres are raises, the first fluid (e.g., CO₂) flows over the liquid sorbent where one or more chemical species is captured, and a lean fluid exits the system. During regeneration, louvres are lowered, air is vacuumed out of the system, and a heated gas (steam) is transported over the liquid sorbent to strip the one or more chemical species. Purification (e.g., via condensation) of the liquid sorbent from the effluent stream yields a purified chemical species (e.g., CO₂).

### DETAILED DESCRIPTION

Before the present disclosure is described in further detail, it is to be understood that the invention is not limited to the particular embodiments described. It is also to be understood that the terminology used herein is for the purpose of describing particular embodiments only, and is not intended to be limiting. The scope of the present invention will be limited only by the claims. As used herein, the singular forms “a”, “an”, and “the” include plural embodiments unless the context clearly dictates otherwise.

It should be apparent to those skilled in the art that many additional modifications beside those already described are possible without departing from the inventive concepts. In interpreting this disclosure, all terms should be interpreted in the broadest possible manner consistent with the context. Variations of the term “comprising” should be interpreted as referring to elements, components, or steps in a non-exclusive manner, so the referenced elements, components, or steps may be combined with other elements, components, or steps that are not expressly referenced. Embodiments referenced as “comprising” certain elements are also contemplated as “consisting essentially of” and “consisting of” those elements.

In places where ranges of values are given, this disclosure explicitly contemplates other combinations of the lower and upper limits of those ranges and sub-ranges that fall therein, which may not be explicitly recited. For example, recitation of a value between 1 and 10 also contemplates values, e.g., from 2 to 9, from 2 to 8, or from 3 to 4. Ranges identified as being “between” two values are inclusive of the end-point values. For example, recitation of a value between 1 and 10 includes the values 1 and 10.

Features of this disclosure described with respect to a particular method, apparatus, composition, or other aspect of the disclosure can be combined with, substituted for, integrated into, or in any other way utilized with other methods, apparatuses, compositions, or other aspects of the disclosure, unless explicitly indicated otherwise or necessitated by the context. For clarity, an aspect of the invention described with respect to one method can be utilized in other methods described herein, or in apparatuses or with compositions described herein, unless context clearly dictates otherwise.

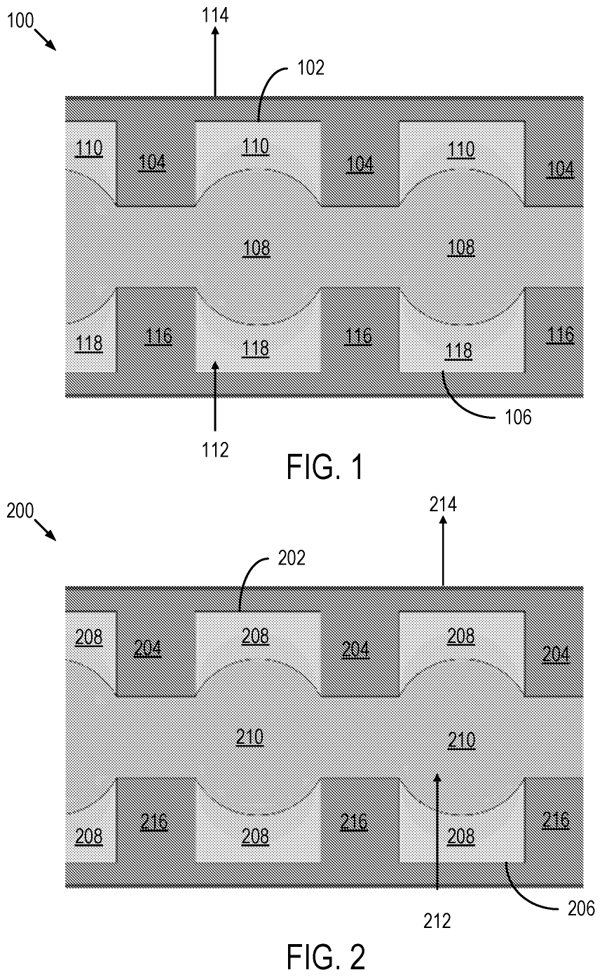

Referring to FIG. 1, a mass transfer apparatus 100 is depicted. The mass transfer apparatus 100 includes a first substrate surface 102 having a textured omniphobic surface 104 or re-entrant features. The mass transport device 100 include a second substrate surface 106 and a liquid sorbent 108 positioned between the first substrate surface 102 and the second substrate surface 106.

As used herein, the term “omniphobic” is used to designate a material as being repellent towards all liquids, particularly being repellant to water, polar organic, and non-polar organic liquids. In case of water, the contact angle between a water droplet and the omniphobic material surface is equal to or higher than 90°. In the case of polar organic and non-polar organic liquids, the contact angle between the liquid droplet and the omniphobic material surface is equal to or higher than 90°. In some embodiments, the textured omniphobic surface 104 prevents complete wetting of the surface and consequently a plurality of nano- and/or microchannels 110 are formed between liquid sorbent 108 and the first substrate surface 102.

As used herein, the term “re-entrant features” refers to structures (e.g., nano- and/or microscale spikes, bumps, pillars or posts) that maintain a non-wetting state for liquids such as low surface tension liquids (e.g., surface tension less than 35 mN/m), and may obtain a non-wetting state in the absence of a low energy hydrophobic coating. Re-entrant structures (e.g., FIG. 4B) may include an overhang on the texture element that reduces or entirely prevents the liquid from penetrating the texture thereby producing a non-wetting state. Without being bound to a particular theory, it is contemplated that when a liquid is placed on the re-entrant surface having a high-aspect-ratio of re-entrant features, the liquid assumes a state that minimizes its free energy and the liquid remains in contact with the re-entrant features. This, in turn, prevents complete wetting of the surface below the re-entrant features. As a result, a plurality of nano- and/or microchannels 110 are formed between the liquid sorbent 108 and the first support substrate 102 having re-entrant features.

As used herein, the term “Cassie-Baxter state” refers to a liquid sorbent coupled to a textured omniphobic surface or a textured surface having re-entrant features, where the liquid sorbent does not completely wet the substrate surface and forms nano- and/or microchannels 110 or gaps filled with a fluid other than the liquid sorbent therebetween.

In some cases, the first and second substrate surface 102, 106 can be located on two separate substrates (e.g., two plates positioned proximate to one another). In some cases, the first and second substrate surface 102, 106 can be located on the same substrate (e.g., a substrate having a channel extending therein where the first and second substrate surface 102, 106 are on opposing surfaces of the channel).

The mass transfer apparatus 100 includes an inlet 112 (e.g., front face of apparatus 100 in FIG. 1) for introducing a first fluid into the plurality of microchannels 110, and an outlet 114 (e.g., back face of apparatus 100 in FIG. 1) for removing the first fluid from the plurality of microchannels 110. In some embodiments, each respective microchannel 110 may form a single channel that extends the length of the apparatus 100. In some embodiments, the microchannels 110 are partially or fully interconnected and in fluid communication with one another. The liquid sorbent 108 is positioned between the first substrate surface 102 and the second substrate surface 106 in a Cassie-Baxter state, and is configured to reversibly capture at least one chemical species from the first liquid as it flows through the apparatus 100.

As shown in FIG. 1, the apparatus 100 may include a second substrate surface 106 that includes a textured omniphobic surface 116 or a textured surface having re-entrant features. The liquid sorbent 108 contacts the textured omniphobic surface 116 or re-entrant features in a Cassie-Baxter state to form a plurality of microchannels 118 positioned between the second substrate surface 106 and the liquid sorbent 108. The microchannels 118 may be placed in fluid communication with the same inlet 112 along with microchannels 110. Alternatively, separate inlets may be used for each set of microchannels 110, 118.

Although not depicted in FIG. 1, in some embodiments, the second substrate surface 106 is smooth. In some embodiments, the second substrate surface 106 is free of an omniphobic textured surface 116.

In some cases, a perforated cover (not shown) may surround the liquid sorbent 108. In some embodiments, the perforated cover prevents or hinders the flow of liquid sorbent 108 along the length (e.g., into the page) of the apparatus 100. In some cases, the perforated cover may have a shape that conforms to the meniscus of the liquid sorbent 108 at the inlet 112 and outlet 114 of the apparatus 100.

In some embodiments, the at least one microchannels 110, 118 include one or more baffle. Baffles may be formed from the same material as the substrate surfaces 102, 106 and project into the respective microchannel 110, 118 to facilitate mixing. Alternatively or additionally, the baffles may be composed of a baffle fluid having density that is different than the first fluid. For example, for microchannel 118 the baffle fluid may have a density that is greater than the first fluid such that the baffle fluid rests on the second support surface 106. In some embodiments, the baffle fluid may have a density that is less than the first fluid such that the baffle fluid rests on the first support surface 102.

The substrate surfaces 102, 106 can be composed of one or more plastics, one or more polymers, one or more elastomers, or a combination thereof. Plastics, polymers and elastomers have significant advantages in their being lightweight, relatively inexpensive (compared to metals), easier to manufacture, and corrosion resistant (which is a major consideration for state of the art sorbent amines). However, the ultralow thermal conductivity of polymers (˜0.2 W/mK) can hinder heat removal (CO₂ absorption by amines is exothermic) and create (in some situations) life-degrading hot spots during steam stripping. In some situations, the plastics, polymers are selected such that cooling/heating needs are catered to by the air/flue gas or steam only. In such a scenario, a plastic mass exchanger can, in fact, significantly cut down heat losses due to its low thermal conductivity, and low thermal mass. Alternatively, the plastic/polymer substrates herein may include conductive fillers (e.g., boron nitride) to enhance the thermal properties. Plastics/polymers with thermal conductivities approaching 10 W/(mK) are commercially available, and some materials can be 3D printed as well.

The substrates surfaces 102, 106 can include plastics, polymers, or elastomers selected from, but not limited to, polymethyl methacrylate (PMMA), polycarbonate, polyethylene, polytetrafluoroethylene (PTFE), epoxy, polyurethane, silicone, butadiene rubber (BR), styrene-butadiene rubber (SBR), copolymers and other combinations of thermoplasic and thermoset polymers thereof.

In certain cases, the substrate surfaces 102, 106 can include a metal, an alloy, or a combination thereof. Metals have the advantage of high thermal conductivity, which facilitates thermal management of the apparatus 100. Suitable metals include, but are not limited to, aluminum, copper, steel, alloys thereof, or combinations thereof.

In some embodiments, the first substrate surface 102 is plastic, a polymer, an elastomer or combinations thereof and the second substrate surface 106 is a metal, alloy, or combination thereof. In some embodiments, the first substrate surface 102 is a metal, alloy, or combination thereof, and the second substrate surface 106 is plastic, a polymer, an elastomer or combinations thereof.

The first substrate surface 102 and the second substrate surface 106 may optionally include one or more channel proximate to the surface (e.g., the channel is built into the substrates) for carrying a heated fluid. The heated fluid flowing through the channel proximate to the first substrate surface 102 may be heated to a different temperature than the channel proximate to the second substrate surface 106. The temperature difference between these channels provides a temperature gradient for thermocapillary stress generation. Thermocapillary stress promotes mixing in the sorbent to speed up selective uptake of the chemical species of interest (e.g., CO₂), and also release of the same during generation.

The substrate surfaces 102, 106 may be textured using any method including, chemical etching, spray coating, solution immersion, sol-gel methods, electrodeposition, vapor deposition, laser processing, plasma deposition or molding. These processes can be used on metals as well as polymers and plastics.

The textured omniphobic surfaces 104, 116 can be coated onto a substrate having a texturized surface. In this case, the substrate may be a material that is not omniphobic, and the coating may be omniphobic. Suitable omniphobic materials include, but are not limited to, polytetrafluoroethylene (PTFE), silane, or other low surface energy coatings and combinations thereof.

The textured omniphobic surface 104, 116 may have a patterned surface, an irregular surface, a hierarchical surface, a surface with re-entrant features, or combinations thereof. The textured omniphobic surface 104, 106 may include an open cell surface having projections, pillars, or ridges having a height from 1 micron to 1 mm. In some embodiments, at least a portion of the projections, pillars, or ridges are spaced apart at a distance from 1 micron to 1 mm. Images of exemplary open cell surfaces are shown in FIG. 4(A-B) and FIG. 5.

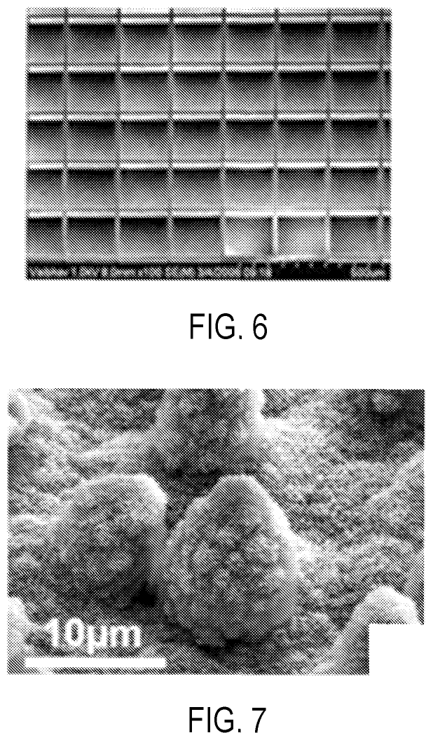

In certain situations, the textured omniphobic surface 104, 116 is in a closed-cell arrangement (e.g., forms bricks or other closed geometries on the surface). An image of an exemplary closed cell surface is shown in FIG. 6.

Textured omniphobic surfaces with hierarchical structures or roughness may improve the omniphobicity of the surface. As shown in FIG. 7, hierarchical levels have multiple (e.g., greater than two) levels of roughness on different feature sizes. The hierarchical structures or roughness may be present as nano- and/or microscale features.

The liquid sorbent 108 is typically immobilized between the first substrate surface 102 and the second substrate surface 106. In some cases, the liquid sorbent 108 is in fluid communication with a reservoir comprising usable amounts of the liquid sorbent 108. A pump may be operationally configured to transport the liquid sorbent 108 from the reservoir to the apparatus 100. The pump may also transport the liquid sorbent 108 between the inlet 112 and outlet 114 during operation of the apparatus 100. The Cassie-Baxter state may be maintained while transporting the liquid sorbent 108 between the inlet 112 and the outlet 114. In some embodiments, the liquid sorbent 108 may be transported from the reservoir via capillary pressure-based wicking or hydrostatic pressure of the sorbent liquid 108 from the reservoir to the mass transfer apparatus 100. In this regard, the apparatus 100 may self-compensate for any sorbent loss due to evaporation during regeneration (e.g., during steam heating or otherwise).

Porous textures and/or materials may be incorporated into the mass transfer apparatus 100, which can be used for wicking and immobilizing the liquid sorbent 108. For example, pipes including sintered copper may serve as a wick to drive fluid from the reservoir into the apparatus 100. The porous texture and/or material may include axial grooves running along its length to wick the liquid sorbent 108.

The mass transfer apparatus 100 may be used to selectively capture one or more chemical species of interest from a variety of fluids and applications. In some embodiments, the liquid sorbent 108 selectively absorbs the chemical species from a variety of fluid streams. For example, the first fluid introduced into the apparatus 100 may be gaseous (e.g., air, flue gas, vapor containing a contaminant), where the liquid sorbent 108 selectively captures one or more chemical species of interest in the gaseous stream (e.g., CO₂, nitrogen oxides, sulfur oxides, the contaminant, dust, etc.). Alternatively, in a two liquid system, the first fluid introduced into the apparatus 100 may be a liquid (hydrophobic or hydrophilic), where the liquid sorbent 108 selectively captures one or more chemical species of interest in the liquid stream (e.g., a drug molecule, a biomolecule, gaseous component to degas the liquid, carbon dioxide in ocean water, salt to desalinate the liquid, etc.).

The liquid sorbent 108 can be configured to reversibly capture carbon dioxide from the first liquid. The first fluid may be gaseous (e.g., air, flue gas, etc.) or liquid (e.g., CO₂-containing liquid, such as ocean water). The liquid sorbent is selected from at least one of an alkanolamine-based absorbent, an ionic liquid-based absorbent, deep eutectic solvent, a dimethylether-based absorbent, or a propylene glycol-based absorbent.

The alkanolamine-based absorbent can be selected from monoethanolamine (MEA), dethanolamine (DEA), N-methyldiethanolamine (MDEA), aminoethylethanolamine (AEEA), piperazine (PZ), aminomethyl propanol (AMP), diethylenetriamine (DETA), or combinations thereof.

The ionic liquid-based absorbent can be selected from 1-n-butyl-3-methylimidazolium bis(trifluoromethylsulfonyl)imide, 1,2-dimethyl-3-propylimidazolium bis(trifluoromethylsulfonyl)imide, 1-butyl-3-methylpyridinium bis(trifluoromethyl sulfonyl)imide, 1-(3,4,5,6-perfluorohexyl)-3-methylimdazolium bis(trifluoromethyl sulfonyl)imide, or 1-n-butyl-3-methylimidazolium tetrafluoroborate.

The present disclosure provides a process for mass transfer using the apparatus 100. The process includes feeding the first fluid to the inlet 112 of the plurality of microchannels 110, 118 to flow the first fluid over the liquid sorbent 108 for a duration sufficient for the liquid sorbent 108 to reversibly capture at least one chemical species from the first liquid. The process further includes removing the first fluid from the plurality of microchannels 110, 118, and regenerating the liquid sorbent by contacting the liquid sorbent to a second fluid, where the regeneration releases the at least one chemical species from the liquid sorbent 108 into the second fluid (e.g., steam or depressurized air).

In some cases, regenerating the liquid sorbent 108 can include contacting the liquid sorbent 108 with a heated fluid (e.g., steam or heated inert gas) at a temperature sufficient to release the at least one chemical species from the liquid sorbent 108. In some circumstances, the process includes applying a vacuum to the plurality of microchannels 110, 118, where regeneration of the liquid sorbent 108 and release of the chemical species of interest from the liquid sorbent 108 occurs via depressurization-induced sorbent degassing.

Referring to FIG. 2, a mass transfer apparatus 200 is depicted. The mass transfer apparatus 200 includes a first substrate surface 202 having a textured omniphilic surface 204. The mass transport device 200 includes a second substrate surface 206 spaced from the first substrate surface 202 to form at least one microchannel 210 between the first substrate surface 202 and the second substrate surface 206. The mass transfer apparatus 200 includes an inlet 212 for introducing a first fluid into the at least one microchannel 210 and an outlet 214 for removing the first fluid from the at least one microchannel 210. The mass transfer apparatus 200 includes a liquid sorbent 208 positioned between the first substrate surface 202 and the second substrate surface 206, where the liquid sorbent 208 contacts the textured omniphilic surface 204 in a Wenzel state, and is selectively configured to reversibly capture at least one chemical species from the first fluid in the at least one channel 210.

As used herein, the term “omniphilic” is used to designate the feature as being attractive towards all liquids, particularly being attractive to water, polar organic, and non-polar organic liquids. In case of water, the contact angle between a water droplet and the omniphilic material surface is equal to or less than 90°. In the case of polar organic and non-polar organic liquids, the contact angle between the liquid droplet and the omniphilic material surface is equal to or less than 90°. In some embodiments, the textured omniphilic surface 104 achieves wetting of the first surface structure 202 and/or the second surface structure 206. As used herein, the term “Wenzel state” refers to a liquid sorbent coupled to a textured omniphilc surface, where the liquid sorbent wets the substrate surface. At least one microchannel 210 is then formed between the wetted surfaces.

In some cases, the first and second substrate surface 202, 206 are on two separate substrates (e.g., two plates positioned proximate to one another). In some cases, the first and second substrate surface 202, 206 are on the same substrate (e.g., a substrate having a channel extending therein where the first and second substrate surface 202, 206 are on opposing surfaces of the channel).

As shown in FIG. 2, the apparatus 200 may include a second substrate surface 206 that includes a textured omniphilic surface 216. The liquid sorbent 208 contacts the textured omniphilic surface 216 on the second support substrate in a Wenzel state.

Although not depicted in FIG. 2, in some embodiments, the second substrate surface 206 is smooth. In some embodiments, the second substrate surface 106 is free of an omniphilic textured surface 116.

In some cases, a perforated cover (not shown) may cover the liquid sorbent 208 to facilitate keeping the liquid sorbent 208 in the wells on the first substrate surface 202 and the second substrate surface 206 during operation.

The substrate surfaces 202, 206 may comprise or be composed of the same materials as the substrate surfaces 102, 106.

In some cases, the substrate surfaces 202, 206 are coated with an omniphilic material. Suitable omniphilic materials include, but are not limited to, high surface energy materials such as metals, high surface energy polymers, glass, materials coatings with high energy on their surface (e.g., oxides, nitrides, etc), or combinations thereof.

The first substrate surface 202 and the second substrate surface 206 may optionally include one or more channel proximate to the surface (e.g., the channel is built into the substrates) for carrying a heated fluid. The heated fluid flowing through the channel proximate to the first substrate surface 202 may be heated to a different temperature than the channel proximate to the second substrate surface 206. The temperature difference between these channels provides a temperature gradient for thermocapillary stress generation. Thermocapillary stress promotes mixing in the sorbent to speed up selective uptake of the chemical species of interest (e.g., CO₂) by the sorbent, and also release of the same during generation.

The textures on the substrate surfaces 202, 206 may be formed using the same methods described with respect to apparatus 100, and may include the same geometries and textures.

The mass transfer apparatus 200 may be used in the same applications and using the same sorbents and fluids described with respect to apparatus 100, except the liquid sorbent 208 is in a Wenzel state rather than in a Cassie-Baxter state.

The present disclosure provides a process for mass transfer using apparatus 200. The process includes feeding the first fluid to the inlet of the at least one microchannel 210 to flow the first fluid over the liquid sorbent 208 for a duration sufficient for the liquid sorbent 208 to reversibly capture the at least one chemical species from the first liquid. The method further includes removing the fluid from the at least one microchannel 210, and regenerating the liquid sorbent 208 by contacting the liquid sorbent to a second fluid, wherein the regeneration releases the at least one chemical species from the liquid sorbent 208 into the second fluid.

In some cases, regenerating the liquid sorbent 208 includes contacting the liquid sorbent 208 with a heated fluid (e.g., steam) at a temperature sufficient to release the at least one chemical species from the liquid sorbent 208. In some embodiments, the process includes applying a vacuum to the at least one microchannels 210, wherein regeneration of the liquid sorbent 208 and release of the chemical species of interest from the liquid sorbent 208 occurs via depressurization-induced sorbent degassing.

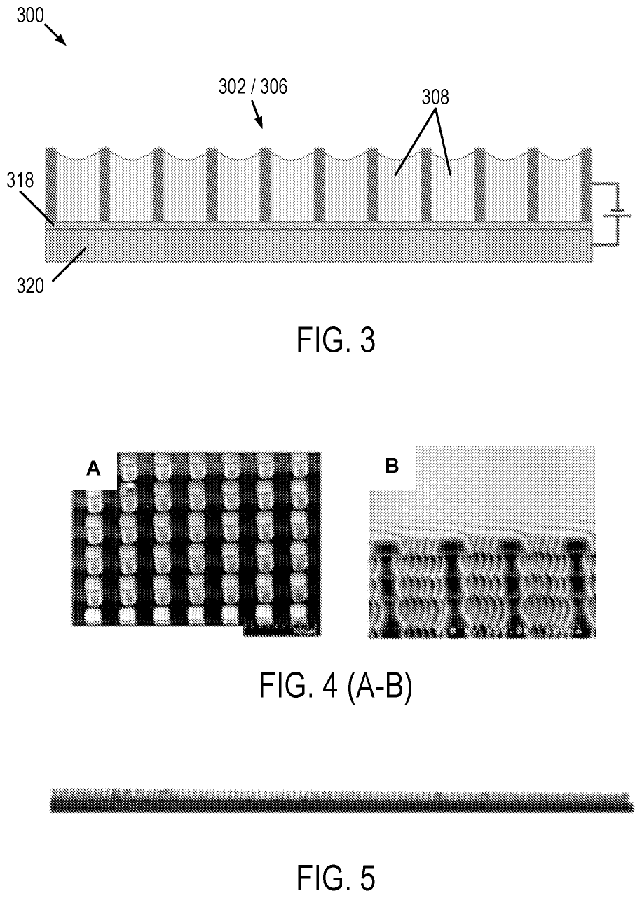

Referring to FIG. 3, an alternate configuration 300 for the first and/or second substrate surface 302, 306 having an omniphilic surface is illustrated in accordance with embodiments of the present disclosure. In this configuration, the first and/or second substrate surface 302, 306 comprise an electrically conducting material. The alternate configuration 300 includes an electrically insulating spacer 318 configured between the first or second substrate surface 302, 306 and a counter electrode 320. In some embodiments, a facial surface of the electrically insulating spacer 318 is in direct contact with a facial surface of the first or second substrate. In some embodiments, a facial surface of the electrically insulating spacer 318 is in direct contact with the counter electrode 320.

In this configuration, the liquid sorbent 308 comprises a redox active solvent that captures the at least one chemical species from the first fluid upon application of an applied voltage across the counter electrode 320 and the first or second substrate surface 302, 306. In this configuration 300, the first and/or second substrate 302, 306 may act as an electrode. The liquid sorbent 308 is configured to release the at least one chemical species upon reversal of the applied voltage. The redox active moieties in the redox active solvent may be covalently attached to the textured surface or dispersed in the liquid sorbent 308.

Suitable redox active solvents include, but are not limited to, quinone-based solvents, pyrimines, thiolates, or combinations thereof.

Suitable counter electrodes 320 include, but are not limited to, materials comprising ferrocene or LiFePO₄.

The present disclosure provides various advantages. First, the provided apparatus and methods offer an integrated unit for selective sorption and sorbent regeneration. This may replace separate absorber and desorber columns as is used in conventional methods, and will reduce CAPEX. The nano- or micro-channels described herein offer enhanced surface area for mass transfer, allowing for compact sorption of the desired chemical species. The smaller hydraulic diameter of the apparatus increases the mass transfer coefficient associated with driving sorption, and thus increases efficiency. In some embodiments, the liquid sorbent material is immobilized on top of the omniphobic structures (non-wetting) or inside the omniphilic structures (wetting). This reduces fluid handling requirements and reduces energy costs during operation. Thermocapillary stresses are proposed to enhance diffusion (via advection). The proposed plastic/polymeric materials have benefits in weight reduction, cost and corrosion-resistance. These materials half the thermal mass of metals, which reduces thermal energy consumption and losses.

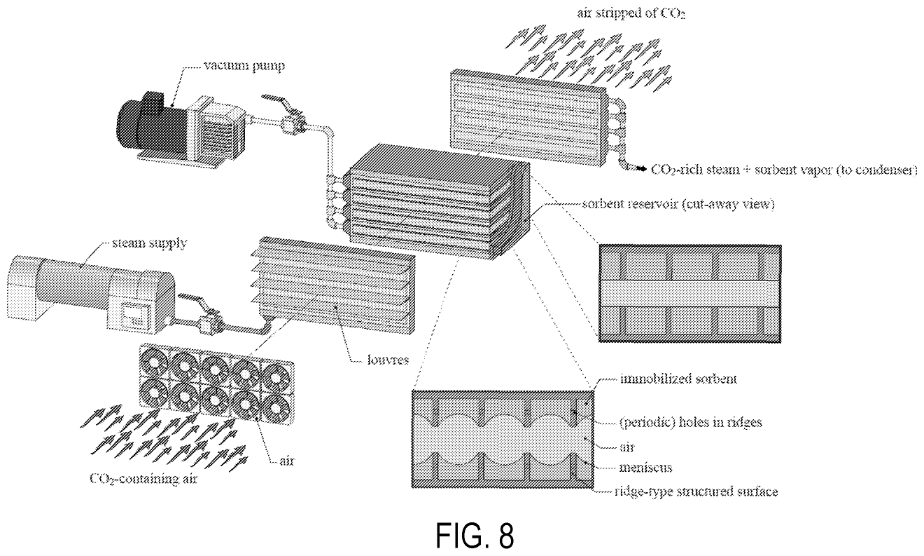

Referring to FIG. 8, an exploded view of one version of a mass exchanger, consistent with the present disclosure, is shown. The mass exchanger shown here include auxiliary components. Priming of SLIPS is achieved via capillary wicking of sorbent in side reservoir per (periodic) holes in ridges. In absorption mode, front and rear (rear version not shown) louvres are raised, CO₂-containing air flows over immobilized sorbent and CO₂-lean air egresses to the ambient. To regenerate sorbent, louvres are lowered, air is vacuumed out of mass exchanger and, subsequently, steam flows over the immobilized sorbent to strip it of CO₂. Condensation of sorbent vapor and steam from effluent in regeneration mode (not shown) yields pure CO₂ stream.

The present disclosure has described one or more preferred embodiments, and it should be appreciated that many equivalents, alternatives, variations, and modifications, aside from those expressly stated, are possible and within the scope of the invention.

1. A mass transfer apparatus comprising:
a first substrate surface having a textured omniphobic surface or a plurality of re-entrant features;
a second substrate surface; and
a liquid sorbent positioned between the first substrate surface and the second substrate surface, wherein the liquid sorbent contacts the textured omniphobic surface or the plurality of re-entrant features in a Cassie-Baxter state to form a plurality of microchannels positioned between the first substrate surface and the liquid sorbent, the microchannels having an inlet for introducing a first fluid into the plurality of microchannels and an outlet for removing the first fluid from the plurality of microchannels, wherein the liquid sorbent is configured to reversibly capture at least one chemical species from the first liquid.

2. The mass transfer apparatus of claim 1, wherein the second substrate surface includes a textured omniphobic surface, and wherein the liquid sorbent contacts the textured omniphobic surface on the second substrate surface in a Cassie-Baxter state to form a plurality of microchannels positioned between the second substrate surface and the liquid sorbent, and wherein the microchannels are in fluid communication with the inlet and the outlet.

3. The mass transfer apparatus of claim 1 or 2, further comprising a perforated cover positioned between the liquid sorbent and the first substrate surface.

4. The mass transfer apparatus of any one of the preceding claims, wherein the textured omniphobic surface includes polytetrafluoroethylene (PTFE), silane, other low surface energy coatings, or combinations thereof.

5. The mass transfer apparatus of any one of the preceding claims, wherein at least one of the first substrate surface or the second substrate surface includes a conductive filler.

6. The mass transfer apparatus of any one of the preceding claims, wherein the second substrate surface comprises a metal, an alloy, or combinations thereof.

7. The mass transfer apparatus of any one of the preceding claims, wherein the first substrate or the second substrate comprise a material selected from polycarbonate, polyethylene, polytetrafluoroethylene (PTFE), epoxy, polyurethane, silicone, copolymers and combinations thereof.

8. The mass transfer apparatus of any one of the preceding claims, wherein the liquid sorbent is immobilized between the first substrate surface and the second substrate surface.

9. The mass transfer apparatus of any one of the preceding claims, wherein the liquid sorbent is in fluid communication with a reservoir comprising the liquid sorbent, and the mass transfer apparatus further comprises a pump for flowing the liquid sorbent between the inlet and the outlet.

10. The mass transfer apparatus of any one of the preceding claims, wherein the liquid sorbent is configured to reversibly capture carbon dioxide from the first liquid.

11. The mass transfer apparatus of claim 10, wherein the liquid sorbent is selected from at least one of an alkanolamine-based absorbent, an ionic liquid-based absorbent, a dimethylether-based absorbent, or a propylene glycol-based absorbent.

12. The mass transfer apparatus of claim 11, wherein the alkanolamine-based absorbent is selected from monoethanolamine (MEA), dethanolamine (DEA), N-methyldiethanolamine (MDEA), aminoethylethanolamine (AEEA), piperazine (PZ), aminomethyl propanol (AMP), diethylenetriamine (DETA), or combinations thereof.

13. The mass transfer apparatus of claim 12, wherein the ionic liquid-based absorbent is selected from 1-n-butyl-3-methylimidazolium bis(trifluoromethylsulfonyl)imide, 1,2-dimethyl-3-propylimidazolium bis(trifluoromethylsulfonyl)imide, 1-butyl-3-methylpyridinium bis(trifluoromethyl sulfonyl)imide, 1-(3,4,5,6-perfluorohexyl)-3-methylimdazolium bis(trifluoromethyl sulfonyl)imide, or 1-n-butyl-3-methylimidazolium tetrafluoroborate.

14. The mass transfer apparatus of any one of the preceding claims, wherein the first fluid comprises carbon dioxide.

15. The mass transfer apparatus of any one of the preceding claims, wherein the first fluid comprises air, flue gas, or combinations thereof.

16. The mass transfer apparatus of any one of the preceding claims, wherein the textured omniphobic surface is selected from a patterned surface, an irregular surface, a hierarchical surface, or combinations thereof.

17. The mass transfer apparatus of any one of the preceding claims, wherein the textured omniphobic surface includes a pillared texture, where pillars in the pillared texture have a height from 1 micron to 1 mm.

18. A process for mass transfer using the mass transfer apparatus of any one of the preceding claims, the process comprising:
feeding the first fluid to the inlet of the plurality of microchannels to flow the first fluid over the liquid sorbent for a duration sufficient for the liquid sorbent to reversibly capture the at least one chemical species from the first liquid;
removing the first fluid from the plurality of microchannels; and
regenerating the liquid sorbent by contacting the liquid sorbent to a second fluid, wherein the regeneration releases the at least one chemical species from the liquid sorbent into the second fluid.

19. The process of claim 18, wherein regenerating the liquid sorbent include contacting the liquid sorbent with steam, wherein the steam releases the at least one chemical species from the liquid sorbent.

20. The process of claim 18, wherein regenerating the liquid sorbent includes applying a vacuum to the plurality of microchannels, wherein regeneration of the liquid sorbent occurs via depressurization-induced sorbent degassing.

21. A mass transfer apparatus comprising:
a first substrate surface having a textured omniphilic surface;
a second substrate surface spaced from the first substrate surface to form at least one microchannel between the first substrate surface and the second substrate surface; and
a liquid sorbent positioned between the first substrate surface and the second substrate surface, wherein the liquid sorbent contacts the textured omniphilic surface in a Wenzel state, wherein the microchannel having an inlet for introducing a first fluid into the at least one microchannel and an outlet for removing the first fluid from the at least one microchannel, and wherein the liquid sorbent is configured to reversibly capture at least one chemical species from the first liquid.

22. The mass transfer apparatus of claim 21, wherein the second substrate surface includes a textured omniphilic surface, and wherein the liquid sorbent contacts the textured omniphilic surface on the second substrate surface in a Wenzel state, wherein the at least one microchannel is positioned between the first substrate surface and the second substrate surface.

23. The mass transfer apparatus of claim 21 or 22, wherein the omniphilic surfaces includes one or more omniphilic material selected from metals, high surface energy polymers, high surface energy coatings comprising oxides or nitrides, or combinations thereof.

24. The mass transfer apparatus of any one of claim 21 to the immediately preceding claim, wherein at least one of the first substrate surface or the second substrate surface includes a conductive filler.

25. The mass transfer apparatus of any one of claim 21 to the immediately preceding claim, wherein the textured substrate comprises metal, an alloy, or combinations thereof.

26. The mass transfer apparatus of claim 25, wherein the second substrate surface comprises aluminum, copper, steel, alloys or combinations thereof.

27. The mass transfer apparatus of any one of claim 21 to the immediately preceding claim, wherein the liquid sorbent is immobilized on the first substrate surface.

28. The mass transfer apparatus of any one of claim 21 to the immediately preceding claim, wherein the liquid sorbent is configured to reversibly capture carbon dioxide from the first liquid.

29. The mass transfer apparatus of claim 28, wherein the liquid sorbent is selected from at least one of an alkanolamine-based absorbent, an ionic liquid-based absorbent, a dimethylether-based absorbent, or a propylene glycol-based absorbent.

30. The mass transfer apparatus of claim 29, wherein the liquid sorbent is the alkanolamine-based absorbent, wherein the alkanolamine-based absorbent is selected from monoethanolamine (MEA), dethanolamine (DEA), N-methyldiethanolamine (MDEA), aminoethylethanolamine (AEEA), piperazine (PZ), aminomethyl propanol (AMP), diethylenetriamine (DETA), or combinations thereof.

31. The mass transfer apparatus of claim 29, wherein the liquid sorbent is the ionic liquid-based absorbent, wherein the ionic liquid-based absorbent is selected from 1-n-butyl-3-methylimidazolium bis(trifluoromethylsulfonyl)imide, 1,2-dimethyl-3-propylimidazolium bis(trifluoromethylsulfonyl)imide, 1-butyl-3-methylpyridinium bis(trifluoromethyl sulfonyl)imide, 1-(3,4,5,6-perfluorohexyl)-3-methylimdazolium bis(trifluoromethyl sulfonyl)imide, or 1-n-butyl-3-methylimidazolium tetrafluoroborate.

32. The mass transfer apparatus of any one of claim 21 to the immediately preceding claim, wherein the first fluid comprises carbon dioxide.

33. The mass transfer apparatus of any one of claim 21 to the immediately preceding claim, wherein the first fluid comprises air, flue gas, or combinations thereof.

34. The mass transfer apparatus of any one of claim 21 to the immediately preceding claim, wherein the textured omniphilic surface is selected from a patterned surface, an irregular surface, a hierarchical surface, or combinations thereof.

35. The mass transfer apparatus of any one of claim 21 to the immediately preceding claim, further comprising:
a counter electrode coupled to a facial surface of the first substrate surface that is opposite the textured omniphilic surface, and
wherein the liquid sorbent comprises a redox active solvent that selectively captures the at least one chemical species from the first fluid upon application of an applied voltage across the counter electrode and the redox active solvent, and wherein the redox active solvent releases the at least one chemical species upon reversal of the applied voltage.

36. The mass transfer apparatus of claim 35, wherein redox active moieties in the redox active solvent are covalently attached to the textured surface.

37. The mass transfer apparatus of claim 35 or 36, wherein the redox active solvent is selected from quinone-based solvents, pyrimines, thiolates, or combinations thereof.

38. The mass transfer apparatus of any one of claims 35 to 37, wherein the counter electrode includes a material comprises ferrocene or LiFePO₄.

39. A process for mass transfer using the mass transfer apparatus any one of claim 21 to the immediately preceding claim, the process comprising:
feeding the first fluid to the inlet of the at least one microchannel to flow the first fluid over the liquid sorbent for a duration sufficient for the liquid sorbent to reversibly capture the at least one chemical species from the first liquid;
removing the first fluid from the at least one microchannel; and
regenerating the liquid sorbent by contacting the liquid sorbent to a second fluid, wherein the regeneration releases the at least one chemical species from the liquid sorbent into the second fluid.

40. The process of claim 39, wherein regenerating the liquid sorbent include contacting the liquid sorbent with steam, wherein the steam releases the at least one chemical species from the liquid sorbent.

41. The process of claim 39, wherein regenerating the liquid sorbent includes applying a vacuum to the at least one microchannel, wherein regeneration of the liquid sorbent occurs via depressurization-induced sorbent degassing.

42. The mass transfer apparatus or the process of any one of claims 1 to 20, the first substrate surface having the texture omniphobic surface.
